(19) United States
(12) Patent Application Publication
(10) Pub. No.: US 2007/0255788 A1
(43) Pub. Date: Nov. 1, 2007

(54) SYSTEM AND METHOD FOR COLLABORATIVE CONTROL OF A REMOTE SOFTWARE APPLICATION

(75) Inventor: Thanh N. Troung, Salt Lake City, UT (US)

Correspondence Address: THORPE NORTH & WESTERN, LLP., 8180 SOUTH 700 EAST, SUITE 350, SANDY, UT, 84070, US

(73) Assignee: University of Utah Research Foundation, Salt Lake City, UT (US)

(21) Appl. No.: 11/686,241

(22) Filed: Mar. 14, 2007

Related U.S. Application Data
(60) Provisional application No. 60/782,966, filed on Mar. 15, 2006.

(51) Int. Cl. G06F 15/16

(52) U.S. Cl. 709/205

(57) ABSTRACT

A system and method for collaborative control of a software application is disclosed. The system includes a network collaboration control engine configured to connect remote users to share control of an application. A queuing module is configured to assign a control priority in a shared application control queue to the remote users and to determine an application controlling user. An application control module is configured to enable the controlling user in the queuing module to control the shared application based on selected criteria.

### CROSS-REFERENCE TO RELATED APPLICATIONS AND CLAIM OF PRIORITY

Priority of U.S. Provisional patent application, Ser. No. 60/782,966 filed on Mar. 15, 2006, is claimed.

### GOVERNMENT AGENCY

This invention was made with government support under grant number CHE0326027 awarded by National Science Foundation. The Government has certain rights to this invention.

### FIELD OF THE INVENTION

The present invention relates generally to collaborative applications.

### BACKGROUND

Electronic collaboration and conferencing tools allow individuals in many locations to share desktop display and content. These collaboration and conferencing tools enable users to present and share slides, applications, files, or the user's desktop to a large (or small) group of people in real-time using a web browser or networked application. Using networked conferencing as a meeting alternative or to enrich face-to-face meetings is quickly becoming a part of business communications.

Such virtual collaboration tools can reduce the amount of time people spend traveling to and from meetings. Although meetings are an essential part of business, meetings can take up the majority of time in the average business person's day. When meetings are more productive, this can enhance the business value of the meetings.

Scheduled or ad-hoc electronic meetings can reduce costs and increase productivity. Electronic sharing tools encourage collaboration, expedite decision-making, and enhance interactions with customers, partners, and colleagues. In addition, software under development or products can be demonstrated to anyone quickly without significant expense. For example, virtual collaboration can allow users to show electronic slideshows, demonstrate product features, show videos, and review documentation.

Virtual collaboration environments enable users to provide a number of valuable functions due to the nature of electronic sharing. For example, users can jointly view, annotate, or edit word processing documents in real-time. Users can collaborate on presentation material and communicate without the expense of traveling. In addition, users of conferencing systems can deliver high quality, time-critical training without generally worrying about hardware or software issues.

When electronic desktop and application sharing meetings take place, the users may desire to use an electronic whiteboard in the presentation. This allows all the meeting participants to draw or make notes using the whiteboard. In addition, images that are displayed on the whiteboard can be annotated upon.

Another function of collaboration and conferencing tools is the ability to share and transmit a live shared application to participants of a conference. For example, software developers may demonstrate a beta version of their product for customers to allow them to see the current version and provide feedback to the development team. Collaboration tools allow meeting participants to see the live shared application actually running on the presenter's desktop while the presenter is using, demonstrating, and discussing the shared application.

Unfortunately, this type of an application demonstration tends to be a one-way process. Meeting participants can see the application being demonstrated but cannot interact with the application on presenter's desktop.

In a similar manner, the presenter may take over the user's desktop and control an application on the user's desktop. However, seeing the user's desktop in its entirety raises a number of security, performance issues, and privacy issues. Even if both users are working on the application on the participant's side of the system, only one person can practically control the application because otherwise there can be a great deal of confusion as to who is actually controlling the application or mouse pointer at a given point in time.

### BRIEF DESCRIPTION OF THE DRAWINGS

FIG. 1 is a block diagram of a graphical user interface and network organization in accordance with an embodiment of the present invention;

FIG. 2 is a block diagram illustrating an embodiment of the invention with additional communication channels for the users in accordance with an embodiment of the present invention; and

FIG. 3 is a flow chart depicting a method for collaborative control of a software application in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

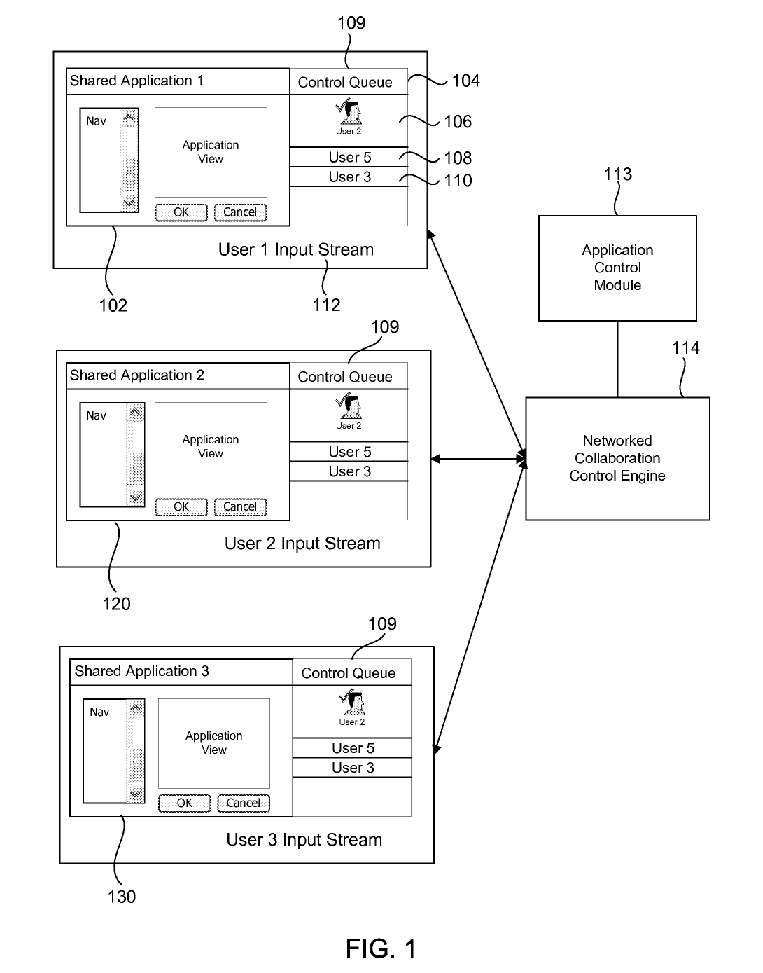

As illustrated in FIG. 1, a block diagram of a system is depicted for collaborative routing and control of an application. In particular, the collaborative control of a remote application that is running on a remote server is effective with this system and method. The present invention allows multiple users to collaborative control the same application as though each user were actually present at a single computer. For example, a remote Java or J2EE application that is running on a remote server can be collaboratively controlled. Alternatively, the remote application can be located on one user's desktop and collaboratively shared between multiple users.

A shared application 102 (or a view of a shared application) can be shared through a collaboration control engine 114. Additional users of the shared application 120, 130 will also be connected via a network connection to the networked collaboration control engine. The users may be connected to the network via a wireless connection, Ethernet or some other networking method known to those skilled in the art. Typically, users will be connected to the network over the Internet, a LAN, a WAN, or some similar type of connection.

In one embodiment, a system for collaborative use of a software application can include the network collaboration control engine. The engine can provide the necessary software to connect at least two remote users to share control of an application. The engine may be located on a centralized server accessible by other collaborators, as discussed above. Alternatively, the engine may be located on one of the collaborators computers or may be divided among a plurality of computers.

A remote uses, as used herein, are users located on separate computing devices, wherein the computing devices are capable of intercommunicating. For example, remote users may be two or more people using computing devices in a class room setting. Alternatively, the remote users may be separated on different continents.

A queuing module 109 can be configured to enable each remote user to be assigned a control priority in a shared application control queue and to determine an application controlling user. In one embodiment, only one user can make changes to the application at a time. This user is the application controlling user. The controlling user can be determined based on the queuing module.

An application control module 113 can be configured to enable the controlling user in the queuing module to control the shared application based on selected criteria. For example, in one embodiment of the invention, the application control is dictated by a user who provides the first user input 112. In the example of FIG. 1, if User 2 uses the mouse or provides user input first, then User 2 will take over the application control and the other users will be blocked from taking actual control of the application. As a result of User 2 taking control of the application, User 2's photo, graphic icon, avatar, or other image 106 can be presented to all of the other users as being in control of the application. Alternatively, User 2's name or networking alias can be displayed instead of a picture or photo.

In an additional embodiment of the invention, a control queue is provided for the other users who are not currently in control of the application. Users listed in the control queue will receive the application control after the current user who is in control (e.g., User 2) gives up his or her control of the application. In FIG. 1, when user 2 gives up control then User 5 and then finally User 3 will receive control of the application.

The control queue depicted in FIG. 1 is a First-In-First-Out (FIFO) type of queue. In other words those who submit commands to request control of the application before other participants will receive that control first. However, other queuing configuration can be used such as a priority based queue.

A user may be defined as giving up control of an application when they are idle for a pre-determined amount of time. For example, if the current user who is in control does not take any action for 2-10 seconds then the control may pass to the next user in the queue. In another embodiment, control may pass to the next user in the queue that takes an action in the application. Alternatively, a pattern recognition method may be used on a user's input stream to determine whether more input from a user is expected.

Additionally, visual or text designators can be displayed when the user has obtained the current control of the application. Even though the user will move to the top of the list or have their picture displayed, another indicator may be provided. The active application area may be surrounded with a green, blue, or highlighted border. This visual change can quickly tell the user that it is time to take action and that they have control of the application. This indicator may be used in addition to the user being at the top of the control queue with their photo. The other collaborative users may also see visual indicators with their view of the application too. Other users may have a yellow border to represent that their application is not active but that they can provide queued up input for later entry.

A red border may be used to show that no user input is being accepted by the application. This may be used in a situation where the master user blocks user input from certain users or from all the other users to the shared application. The master user may also have a group control button that toggles the ability of other users to provide input to the application. This button can be used to filter out stray input when a presenter in providing a presentation. Then the button can be pressed to allow users to provide input after the presentation is over.

A different configuration for control allocation can provide a participation button to users of the shared application. When the users press the participation button, then the users name or photo is inserted into the collaboration so that they can wait their turn to participate in the discussion.

Another method for allocating control can be to give certain individuals a control override button. For example, if one person is considered to be a presenter then he may have the ability to override the other participants in the meeting. Alternatively, the override or “take my turn” button can insert the person at the top of the control queue of the application without any other action by the user. Then when the person's turn arrives they may have 2-15 seconds to start submitting their input.

One alternative embodiment for the user input received from User 5 and User 2 of FIG. 1 is to store the user input in the queue so that user input then gets immediately applied when control transfers to the appropriate user. For example, if User 2 types a word or enters an application command (e.g., pushes F1 or the OK button) then the characters or application events can be stored until User 2 is active and then the commands can be applied.

It is also possible to pick out types of user input that will be applied when the user takes control and types of input that should not be applied. For example, queued up user input that negates the input of those just ahead of them in the queue may be ignored. Similarly, interface controls which are not available after the previous user may be ignored (e.g., a button such as an OK button is no longer accessible).

The system and method described are valuable because they allow users to co-edit documents. A first user can make direct edits to a document. Then the second user can type their changes while the first user is making changes and these changes will be queued up in the control queue 104. When the control passes to the second user, the queued up changes may be immediately made.

Another area where the present invention is valuable is for demonstration applications and allowing the demonstration participants to take part in the demonstration in an orderly manner. In other words, the presenter can show the task or application function, and then any one of the participants can take part, as they desire, without worrying that their commands will cause confusion or take place in a confusing manner. Other types of applications where the present invention may be useful can include technical support, application debugging, and remote application presentations.

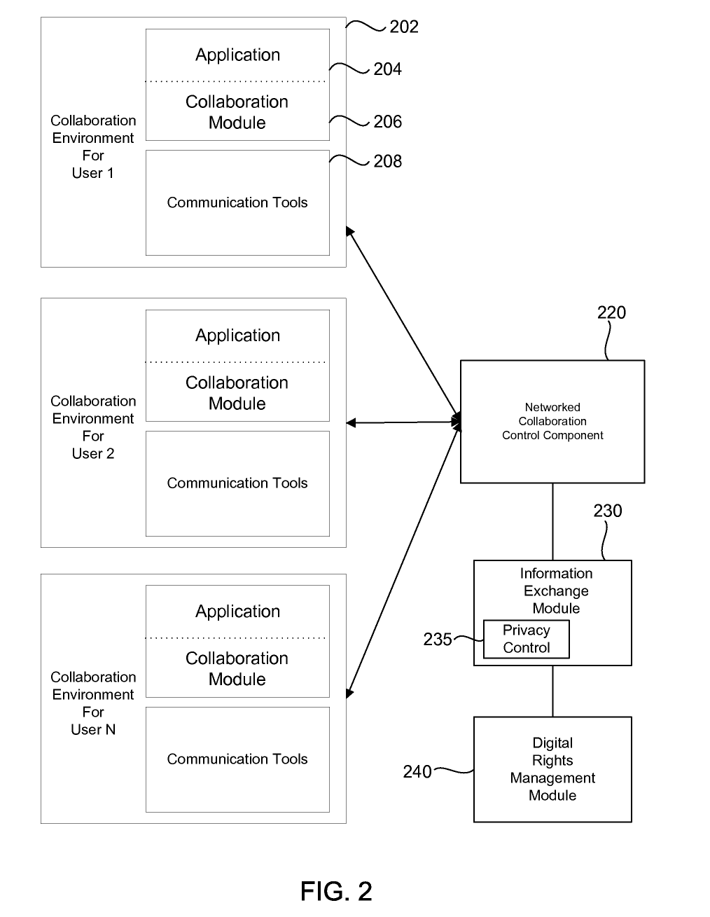

In addition, FIG. 2 illustrates that the present invention may include an information exchange module 230. The information exchange module can be configured to enable remote users to share text, audio, and video in near real time. For example, the information exchange module can provide Voice over Internet Protocol (VOIP), video conferencing, or Instant Messaging applications to enable users to communicate as they collaborate on the shared application. Privacy controls 235 can be provided with the communications tools. A user may not desire to have others view a video feed of them. Thus, the user can turn off any unwanted video or audio of themselves. In a similar manner, a mute button for the video and audio can be provided.

An additional embodiment of the present system and method may have a digital rights management module 240 embedded within the control features. In some situations, there may only be a one or two user license for the application. The collaboration features would then be turned off and the users who were not identified as having the license would only be able to view the application. This function may be implemented by sending an image of what the licensed user is doing with the application or the application may be actually executing on the viewers desktop, but the application can be blocked from receiving unlicensed user input.

In one embodiment, the collaboration software can be loaded on each computing node or desktop station that will be involved in a collaborative control of an application. Alternatively, the collaboration software may be located on a central server accessible over a network connection or through the internet. For example, a java servlet may be located on a server. Each computer that will be used in the collaborative control of an application can run a java applet that interacts with the java servlet on the server.

In one embodiment, the collaboration software can send a copy of the application image and an instance of the application data to each local computing node or desktop station. The same collaboration controls can be in place but the application functionality performed by the controlling user and the modified data portions can be broadcast to each of the workstations and then re-merged into the local view and data store.

A more centralized approach may also be taken. In another embedment, a centralized application can be collaborated upon as described previously. The application can be configured to execute on a centralized server and the application data can also be located and modified on the centralized server. An image of the application can be broadcast to each user but the user interaction will be controlled by the queuing mechanisms described previously.

The shared image of the application can enable each user involved in the collaborative event to see updates to the application that are made by the controlling user. In one embodiment sufficient information can be sent from the controlling user's computing environment to the other users involved in the collaborative event so that each user can see all actions taken by the controlling user in the application, as if the users were watching the controlling user in person.

In another embodiment, the shared image can include sufficient information sent from the controlling user's computer to the other users that allow them to see changes made to the application. The information may be limited to actions taken by the controlling user, such as the active elements within the application that are accessed, as well as graphical or textual information that is added to the application. This information may be sent to the application programming interface (API) of the application loaded on each of the user's computer.

Several situations were described above where some users may not be able to give input to the application at a certain point in time. During these times the communication tools and their respective electronic channels can be left open to allow for open discussion (via text, audio, or video) of the events being applied by the controlling user.

FIG. 2 is a block diagram illustrating the use of additional communication tools in conjunction with the collaborative controls. The communication tools 208 can be tools such as VOIP channels over which all the participants may communicate concerning the collaborative application. The voice channel can also provide for some informal negotiation regarding who may use the application next.

For example, various types of collaborative communication channels can be used to communicate such as instant text messaging, video streaming, white boards, a posting board with threads, an IRC channel, a chat room via a web link, or other nearly instantaneous or generally real-time communication applications that are used over networks. The communication tools 208 can be incorporated into the collaboration environment 202 as a plug-in to the environment or stand-alone communication tools can be activated from the collaboration module 206 with user programmed graphic buttons or pre-defined button functions.

The collaboration module 206 may be a plug-in for the application 204 that is being shared or the collaboration module may be part of a suite of tools that can be configured to point at the desired application. For example, the collaboration plug-in may be a Java or Web plug-in that is incorporated into a remote Java program or a stand-alone executable. Alternatively, the collaboration module may simply ask the user to select the name of the application to be shared from a list or the user may enter the name of the remote or local application (executable image) to be shared.

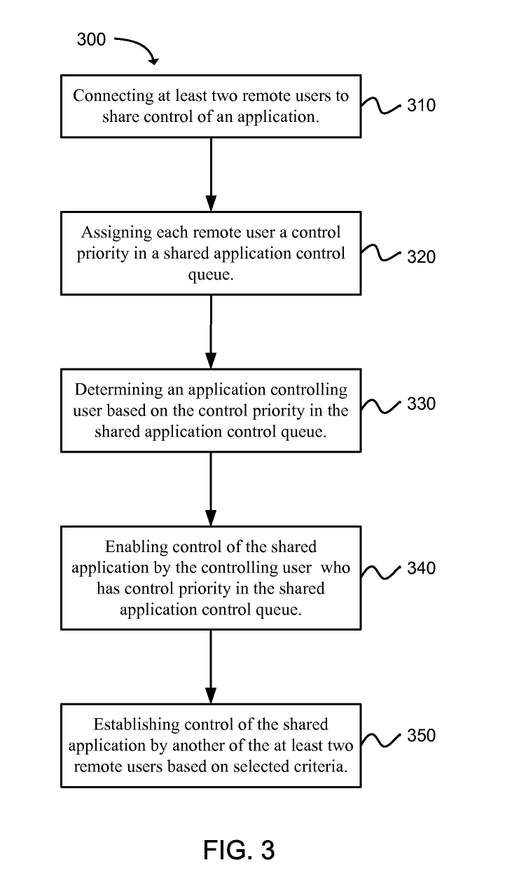

Another embodiment of the invention provides a method 300 for collaborative control of a software application, as depicted in the flow chart of FIG. 3. The method includes the operation of connecting at least two remote users to share control of an application, as depicted in block 310. Each remote user can be assigned a control priority in a shared application control queue, as shown in block 320. The application controlling user can be determined based on the control priority in the shared application control queue, as depicted in block 330. The controlling user that has control priority in the shared application control queue can be enabled to control the application, as shown in block 340. Control of the shared application, as shown in block 350, can then be established by another of the at least two remote users based on selected criteria, as previously discussed.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for collaborative control of an application, comprising:
a network collaboration control engine configured to connect at least two remote users to share control of the application;
a queuing module configured to enable each remote user to be assigned a control priority in a shared application control queue and to determine an application controlling user;
an application control module configured to enable the application controlling user in the queuing module to control the shared application based on the control priority.

2. A system as in claim 1, wherein the control priority assigned is based on an order that the remote users connect to the queuing module.

3. A system as in claim 1, wherein the control priority assigned is based on a predetermined priority of the at least two remote users.

4. A system as in claim 1, wherein the application controlling user is assigned to another of the at least two remote users when the application is idle for a predetermined time.

5. A system as in claim 1, wherein the application controlling user is assigned to another of the at least two remote users based on a pattern recognition scheme of a current controlling user's use of the application.

6. A system as in claim 1, further comprising a visual designator displayed based on the remote user's control priority level.

7. A system as in claim 6, wherein the visual designator is a colored border on a display screen, wherein the color of the designator is based on the remote user's control priority level.

8. A system as in claim 6, wherein the visual designator depicts whether input is accepted by the network collaboration control engine.

9. A system as in claim 1, wherein one of the at least two remote users is selectable as a master user that can control input from remaining users to the application.

10. A system as in claim 9, wherein the master user can control the control priority to become the controlling user.

11. A system as in claim 1, wherein the queuing module further comprises a participation button configured to enable a user to enter the control queue.

12. A system as in claim 1, wherein the network collaboration control engine is configured to store input from the remote users in the shared application control queue, wherein the stored input can be displayed to each of the at least two remote users when the remote user associated with the input becomes the application controlling user.

13. A system as in claim 1, further comprising an information exchange module configured to enable the at least two remote users to share at least one of text, audio, and video.

14. A system as in claim 13, wherein the information exchange module includes at least one of a voice over IP module, an instant messaging module, and a video conferencing module.

15. A system as in claim 13, wherein the network collaboration control engine further comprises a privacy control configured to enable the at least two remote users to deactivate the information exchange module for a selected period.

16. A system as in claim 1, further comprising a digital rights management module configured to determine whether the at least two remote users have sufficient rights to run the shared application.

17. A method for collaborative control of a software application, comprising:
connecting at least two remote users to share control of an application;
assigning each remote user a control priority in a shared application control queue;
determining an application controlling user based on the control priority in the shared application control queue;
enabling control of the shared application by the controlling user who has control priority in the shared application control queue; and
establishing control of the shared application by another of the at least two remote users based on the control priority.

18. A method as in claim 17, wherein assigning each remote user a control priority further comprises assigning a control priority based on an order that the remote users connect to the queuing module.

19. A method as in claim 17, wherein assigning each remote user a control priority further comprises assigning a control priority based on a predetermined priority of the at least two remote users.

20. A method as in claim 17, wherein establishing control of the shared application by another further comprises assigning control to a separate controlling user to another of the at least two remote users when the application is idle for a predetermined time.

21. A method as in claim 17, wherein establishing control of the shared application by another further comprises assigning control to a separate controlling user of the at least two remote users when the application is idle for a predetermined time, wherein the separate controlling user is selected based on activity in the application by the user.
